(19) United States
(12) Patent Application Publication
(10) Pub. No.: US 2025/0188995 A1
(43) Pub. Date: Jun. 12, 2025

(54) TORQUE LIMITER AND POWER TRANSMISSION DEVICE

(71) Applicant: EXEDY Corporation, Osaka (JP)

(72) Inventor: Hiroshi UEHARA, Osaka (JP)

(21) Appl. No.: 18/957,690

(22) Filed: Nov. 23, 2024

(30) Foreign Application Priority Data
Dec. 12, 2023 (JP) 2023-216992

(51) Int. Cl. F16D 7/02

(52) U.S. Cl. CPC F16D 7/025; F16D 2300/22

(57) ABSTRACT

A power transmission device has an annular side plate and an annular support plate spaced apart from it. Multiple auxiliary plates are attached to the support plate. The auxiliary plates are disposed radially outside the support plate and are aligned in an annular shape. A disc spring is disposed between the support plate and the side plate. A first friction material is disposed between the support plate and the disc spring. The first friction material is disposed adjacent to the support plate and the multiple auxiliary plates. An inner peripheral edge of the disc spring is disposed radially outside an outer peripheral edge of the support plate, while being disposed radially inside an outer peripheral edge of each of the plurality of auxiliary plates.

### CROSS-REFERENCE TO RELATED APPLICATIONS

This application is based on and claims the priority benefit of Japanese application 2023-216992 filed on Dec. 22, 2023, the contents of which are incorporated herein by reference.

### TECHNICAL FIELD

The claimed invention relates to a torque limiter and a power transmission device.

### BACKGROUND

There has been proposed a power transmission device including a torque limiter to prevent transmission of excessive torque. For example, a power transmission device disclosed in Japan Laid-open Patent Application Publication No. 2022-55616 includes a damper unit and a torque limiter. The torque limiter includes a clutch composed of a plurality of plates and prevents transmission of excessive torque by slippage of the clutch. The torque limiter includes a support plate for supporting a friction material and a disc spring for pressing the clutch.

From the perspective of cost reduction, it is preferred to take the support plate and the disc spring from a common sheet of plate by so-called nested-based manufacturing. However, each of the support plate and the disc spring has an annular shape; hence, the support plate and the disc spring, if taken from the common sheet of plate by nested-based manufacturing, do not overlap with each other when axially seen. Because of this, a friction material, disposed between the support plate and the disc spring, cannot be uniformly applied with a load.

### SUMMARY OF THE INVENTION

It is an object of the claimed invention to provide a torque limiter in which a friction material can be uniformly applied with a load.

A torque limiter according to a first aspect includes a first side plate, a support plate, a plurality of auxiliary plates, a disc spring, and a first friction material. The first side plate has an annular shape. The support plate is spaced apart from the first side plate at an interval in an axial direction. The support plate has an annular shape. The plurality of auxiliary plates are attached to the support plate. The plurality of auxiliary plates are disposed radially outside the support plate. The plurality of auxiliary plates are aligned in an annular shape. The disc spring is disposed between the support plate and the first side plate in the axial direction. The first friction material is disposed between the support plate and the disc spring in the axial direction. The first friction material is disposed adjacent to the support plate and each of the plurality of auxiliary plates. An inner peripheral edge of the disc spring is disposed radially outside an outer peripheral edge of the support plate, while being disposed radially inside an outer peripheral edge of the each of the plurality of auxiliary plates.

According to the configuration, the plurality of auxiliary plates are attached to the support plate; hence, the first friction material can be sandwiched by the disc spring and the plurality of auxiliary plates. As a result, the friction material can be uniformly applied with a load.

A torque limiter according to a second aspect relates to the torque limiter according to the first aspect and is configured as follows. The support plate includes a plurality of engaging recesses. The plurality of engaging recesses extend radially inward from an outer peripheral surface of the support plate. The each of the plurality of auxiliary plates includes a plate body and an engaging protrusion. The engaging protrusion extends radially inward from the plate body. The engaging protrusion is engaged with corresponding one of the plurality of engaging recesses.

A torque limiter according to a third aspect relates to the torque limiter according to the second aspect and is configured as follows. The engaging protrusion and the corresponding one of the plurality of engaging recesses extend to slant with respect to an imaginary line connecting a center of gravity of the each of the plurality of auxiliary plates and a rotational axis.

A torque limiter according to a fourth aspect relates to the torque limiter according to the second or third aspect and is configured as follows. The engaging protrusion is one of at least two engaging protrusions included in the each of the plurality of auxiliary plates. The at least two engaging protrusions are disposed on both sides of a center of gravity of the each of the plurality of auxiliary plates in a circumferential direction. Each of the at least two engaging protrusions and each of the plurality of engaging recesses extend toward a rotational axis.

A torque limiter according to a fifth aspect relates to the torque limiter according to any of the second to fourth aspects and is configured as follows. The first friction material includes a groove. The groove is provided on a surface of the first friction material coming in contact with the support plate and the each of the plurality of auxiliary plates. The groove is opened radially outward. The groove overlaps with a boundary between the engaging protrusion and the corresponding one of the plurality of engaging recesses as seen in the axial direction.

A torque limiter according to a sixth aspect relates to the torque limiter according to any of the first to fifth aspects and further includes a second side plate, a pressure plate, and a second friction material. The second side plate is disposed to interpose the support plate, the each of the plurality of auxiliary plates, the disc spring, and the first friction material together with the first side plate therebetween. The second side plate has an annular shape. The pressure plate is disposed between the disc spring and the first friction material in the axial direction. The second friction material is disposed between the support plate and the second side plate in the axial direction.

A torque limiter according to a seventh aspect relates to the torque limiter according to any of the second to fifth aspects and further includes a second side plate, a pressure plate, and a second friction material. The second side plate is disposed to interpose the support plate, the each of the plurality of auxiliary plates, the disc spring, and the first friction material together with the first side plate therebetween. The second side plate has an annular shape. The pressure plate is disposed between the disc spring and the first friction material in the axial direction. The second friction material is disposed between the support plate and the second side plate in the axial direction. The first friction material includes a first through hole penetrating therethrough in the axial direction. The second friction material includes a second through hole penetrating therethrough in the axial direction. The support plate includes a first protrusion, a second protrusion, a first region, and a second region. The first protrusion protrudes toward the first friction material to be engaged with the first through hole. The second protrusion protrudes toward the second friction material to be engaged with the second through hole. The first region is provided with the first protrusion and is defined by one pair of engaging recesses disposed adjacent to each other in a circumferential direction among the plurality of engaging recesses. The second region is provided with the second protrusion and is defined by another pair of engaging recesses disposed adjacent to each other in the circumferential direction among the plurality of engaging recesses. The first region is configured to be extended straight from a state thereof bent toward the first friction material when sandwiched by the pressure plate and the second side plate. The second region is configured to be extended straight from a state thereof bent toward the second friction material when sandwiched by the pressure plate and the second side plate.

A torque limiter according to an eighth aspect relates to the torque limiter according to any of the first to seventh aspects and is configured as follows. The disc spring is identical in plate thickness to the support plate.

A power transmission device according to a ninth aspect includes the torque limiter recited in any of the first to eighth aspects and a damper unit. The damper unit includes an input rotor, an output rotor, and an elastic member. The input rotor is configured to be unitarily rotated with the support plate. The elastic member elastically couples the input rotor and the output rotor.

Overall, according to the claimed invention, the friction material can be uniformly applied with a load.

### BRIEF DESCRIPTION OF THE DRAWINGS

FIG. 1 is a front view of a power transmission device in accordance with the claimed invention.

FIG. 2 is a cross-sectional view of the power transmission device taken along zigzag, angled line II-II in FIG. 1.

FIG. 3 is a front view of a support plate.

FIG. 4 is a cross-sectional view of a torque limiter that has not been assembled.

FIG. 5 is a cross-sectional view of the torque limiter that has been assembled.

FIG. 6 is a front view of the support plate to which multiple auxiliary plates have been attached.

FIG. 7 is a front view of each auxiliary plate.

FIG. 8 is a front view of a first friction material.

FIG. 9 is a view of the first friction material taken along arrow IX-IX in FIG. 8.

FIG. 10 is a front view of the torque limiter.

FIG. 11 is a front view of a sheet of plate from which the support plate, a disc spring, and the multiple auxiliary plates are taken.

### DETAILED DESCRIPTION

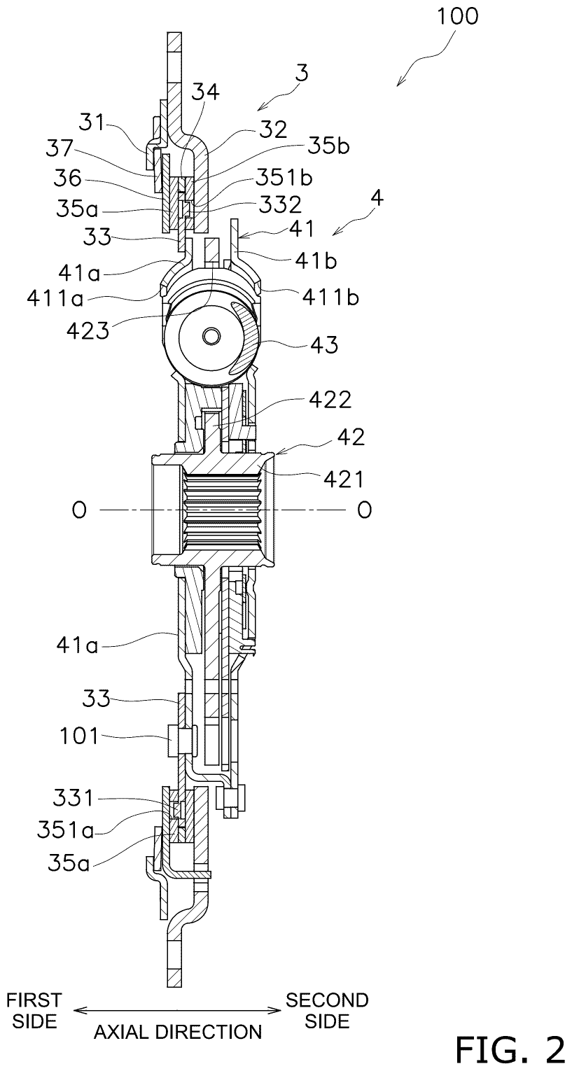

A torque limiter 3 and a power transmission device 100 according to the presently preferred embodiment will be hereinafter explained with reference to drawings. It should be noted that in the following explanation, the term “axial direction” refers to an extending direction of a rotational axis O for both the torque limiter 3 and the power transmission device 100. On the other hand, the term “circumferential direction” refers to a circumferential direction of an imaginary circle about the rotational axis O, whereas the term “radial direction” refers to a radial direction of the imaginary circle about the rotational axis O. Additionally, the term “first side in the axial direction” means the left side in FIG. 2, whereas the term “second side in the axial direction” means the right side in FIG. 2.

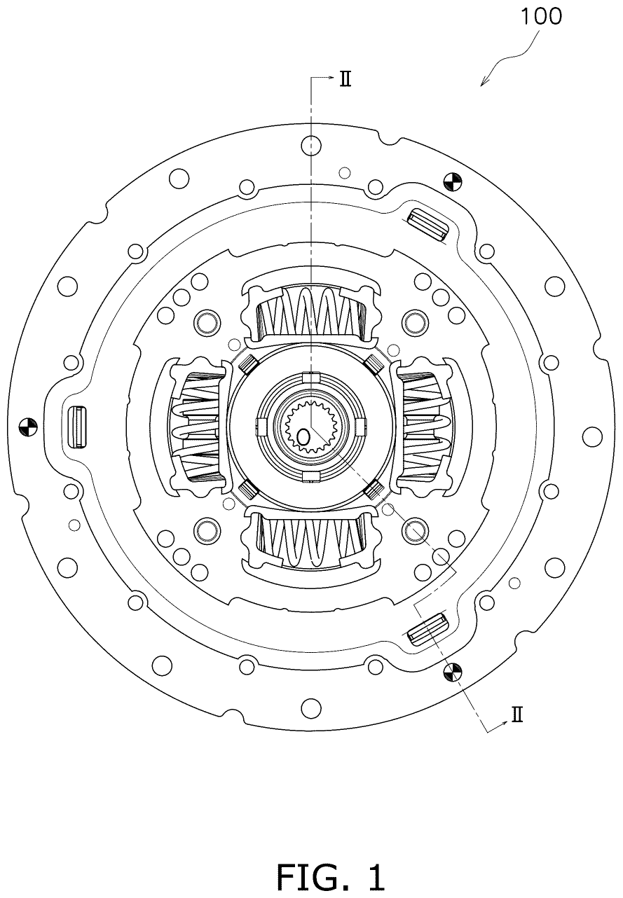

FIG. 1 is a front view of the power transmission device 100, whereas FIG. 2 is a cross-sectional view of the power transmission device 100 taken along zigzag, angled lines II-II in FIG. 1. As shown in FIGS. 1 and 2, the power transmission device 100 includes the torque limiter 3 and a damper unit 4. Basically, the torque limiter 3 and the damper unit 4 are unitarily rotated with each other. The power transmission device 100 is installed between an internal combustion engine (omitted in illustration) and an output-side member (omitted in illustration). It should be noted that the output-side member may, for instance, be an electric motor, a transmission, and so forth. The power transmission device 100 is attached to a flywheel (omitted in illustration). For example, in FIG. 2, the internal combustion engine is disposed on the left side of the power transmission device 100, whereas the output-side member is disposed on the right side of the power transmission device 100. The power transmission device 100 is configured not only to limit torque transmitted between the internal combustion engine and the output-side member, but also to attenuate torque fluctuations.

### Damper Unit

The damper unit 4 is attached to the torque limiter 3. The damper unit 4 is configured to attenuate rotational fluctuations. The damper unit 4 includes an input rotor 41, an output rotor 42, and elastic members 43.

### Input Rotor

The input rotor 41 is configured to be unitarily rotated with a support plate 33 of the torque limiter 3 (to be described). The input rotor 41 includes a first plate 41a and a second plate 41b. Each of the first and second plates 41a and 41b is an annular member including a center hole. The first and second plates 41a and 41b are unitarily rotated with each other. Additionally, the first and second plates 41a and 41b are axially immovable relative to each other.

The first and second plates 41a and 41b are spaced apart from each other at an interval in the axial direction. The second plate 41b is disposed on the second side of the first plate 41a in the axial direction.

The first plate 41a includes a plurality of window portions 411a, while the second plate 41b includes a plurality of window portions 411b. It should be noted that in the presently preferred embodiment, the first plate 41a includes four window portions 411a, while the second plate 41b includes four window portions 411b; however, the window portions 411a, 411b are not limited in number to this.

Not only the window portions 411a, but also the window portions 411b are spaced apart from each other at intervals in the circumferential direction. Not only the window portions 411a, but also the window portions 411b are configured to accommodate the elastic members 43, respectively.

### Output Rotor

The output rotor 42 is configured to transmit the torque, inputted thereto from the input rotor 41, to the output-side member. The output rotor 42 is disposed axially between the first and second plates 41a and 41b. The output rotor 42 is disposed to be rotatable relative to the first and second plates 41a and 41b.

The output rotor 42 includes a hub 421 and a flange plate 422. The hub 421 and the flange plate 422 are integrated as a single member; alternatively, they may be provided as members separated from each other.

The hub 421 has a tubular shape and is disposed in the center hole of the first plate 41a and that of the second plate 41b. The hub 421 is provided with a spline hole, extending in the axial direction, in an inner peripheral part thereof. The spline hole enables an input shaft of the output-side member to be spline-coupled thereto.

The flange plate 422 radially extends from the outer peripheral surface of the hub 421. The flange plate 422 has an annular shape. The flange plate 422 is disposed to be rotatable relative to the first and second plates 41a and 41b. The flange plate 422 is disposed axially between the first and second plates 41a and 41b.

The flange plate 422 includes multiple accommodation holes 423. It should be noted that in the presently preferred embodiment, the flange plate 422 includes four accommodation holes 423; however, the flange plate 422 is not limited in number of accommodation holes to this. The accommodation holes 423 are spaced apart from each other at intervals in the circumferential direction. The accommodation holes 423 are configured to accommodate the elastic members 43, respectively. When axially seen, the accommodation holes 423 are disposed to overlap with not only the window portions 411a, but also the window portions 411b, respectively.

### Elastic Members

The elastic members 43 are configured to elastically couple the input rotor 41 and the output rotor 42 in a rotational direction. The elastic members 43 may, for instance, be coil springs.

The elastic members 43 are accommodated in the accommodation holes 423 of the output rotor 42, respectively. Additionally, the elastic members 43 are accommodated not only in the window portions 411a of the first plate 41a, but also in the window portions 411b of the second plate 41b, respectively.

### Torque Limiter

As shown in FIG. 2, the torque limiter 3 is disposed to be rotatable about the rotational axis O. The torque limiter 3 is disposed on the second side of the flywheel in the axial direction. The torque limiter 3 has an annular shape. The torque limiter 3 is attached to the flywheel.

The torque limiter 3 is configured to limit the torque transmitted between the flywheel and the damper unit 4. In other words, the torque limiter 3 is configured to restrict transmission of a torque in the power transmission device 100 when the torque has a magnitude that is greater than or equal to a predetermined value.

The torque limiter 3 includes a first side plate 31, a second side plate 32, the support plate 33, multiple auxiliary plates 34, a first friction material 35a, a second friction material 35b, a pressure plate 36, and a disc spring 37.

### First Side Plate and Second Side Plate

The first and second side plates 31 and 32 are attached to the flywheel. The first and second side plates 31 and 32 are unitarily rotated with the flywheel. Each of the first and second side plates 31 and 32 has an annular shape. The second side plate 32 is spaced apart from the first side plate 31 at an interval in the axial direction. The second side plate 32 is disposed on the second side of the first side plate 31 in the axial direction. The first and second side plates 31 and 32 interpose therebetween the support plate 33, the respective auxiliary plates 34, the first friction material 35a, the second friction material 35b, the pressure plate 36, and the disc spring 37. The second side plate 32 is larger in plate thickness than the first side plate 31.

### Support Plate

The support plate 33 is an annular plate. The support plate 33 is disposed to be rotatable about the rotational axis O. The support plate 33 is spaced apart from the first side plate 31 at an interval in the axial direction.

The support plate 33 is attached to the input rotor 41. In particular, the support plate 33 is attached to the first plate 41a. For example, the support plate 33 is attached to the first plate 41a by fastening members 101. The support plate 33 is unitarily rotated with the input rotor 41. It should be noted that the support plate 33 is provided as a member separated from the first plate 41a; however, the support plate 33 may be integrated with the first plate 41a as a single member.

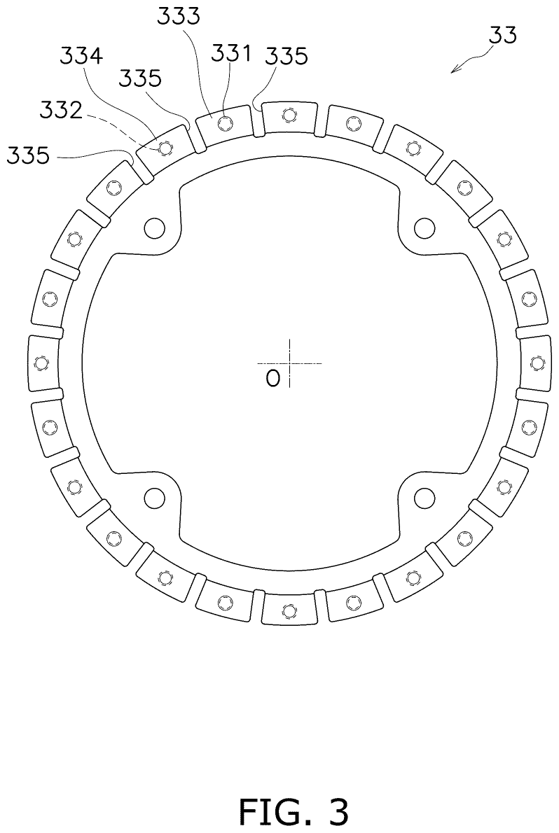

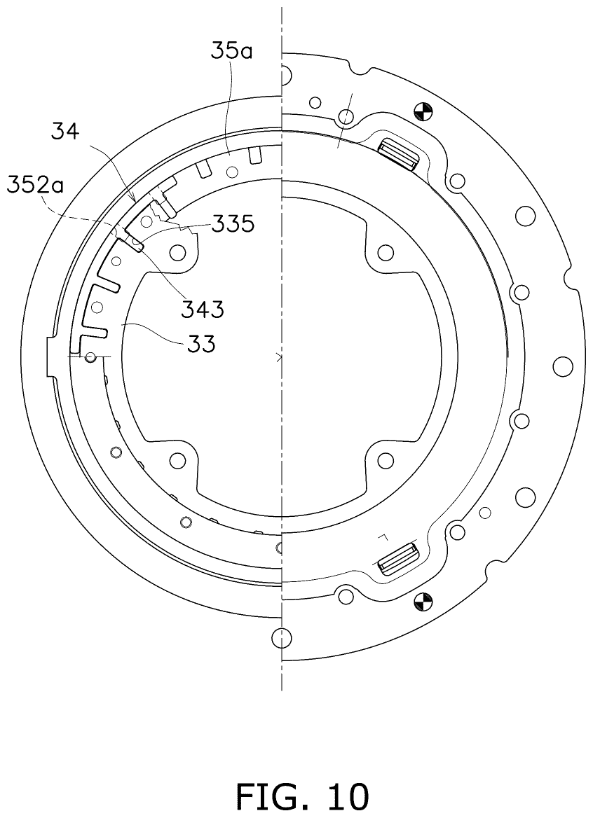

FIG. 3 is a front view of the support plate 33. As shown in FIG. 3, the support plate 33 includes multiple engaging recesses 335. The engaging recesses 335 extend radially inward from the outer peripheral surface of the support plate 33. The distal ends of the engaging recesses 335 are disposed radially inside the inner peripheral edge of the first friction material 35a (see FIG. 10). The engaging recesses 335 are opened radially outward. The engaging recesses 335 are provided in an outer peripheral part of the support plate 33. The engaging recesses 335 penetrate the support plate 33 in the axial direction. The engaging recesses 335 are spaced apart from each other at intervals in the circumferential direction.

As shown in FIGS. 2 and 3, the support plate 33 includes multiple first protrusions 331 and multiple second protrusions 332. The first protrusions 331 and the second protrusions 332 are alternately disposed in the circumferential direction.

The first protrusions 331 protrude toward the first friction material 35a. In other words, the first protrusions 331 protrude to the first side in the axial direction. The first protrusions 331 are engaged with first through-holes 351a of the first friction material 35a (to be described), respectively.

The second protrusions 332 protrude toward the second friction material 35b. In other words, the second protrusions 332 protrude to the second side in the axial direction. The second protrusions 332 are engaged with second through-holes 351b of the second friction material 35b (to be described), respectively.

As shown in FIG. 3, the support plate 33 includes multiple first regions 333 and multiple second regions 334. Each first region 333 is defined by a pair of engaging recesses 335 disposed adjacent to each other in the circumferential direction. Each first region 333 is provided with each first protrusion 331. In other words, amongst the regions between pairs of engaging recesses 335 disposed adjacent to each other in the circumferential direction, those provided with the first protrusions 331 correspond to the first regions 333.

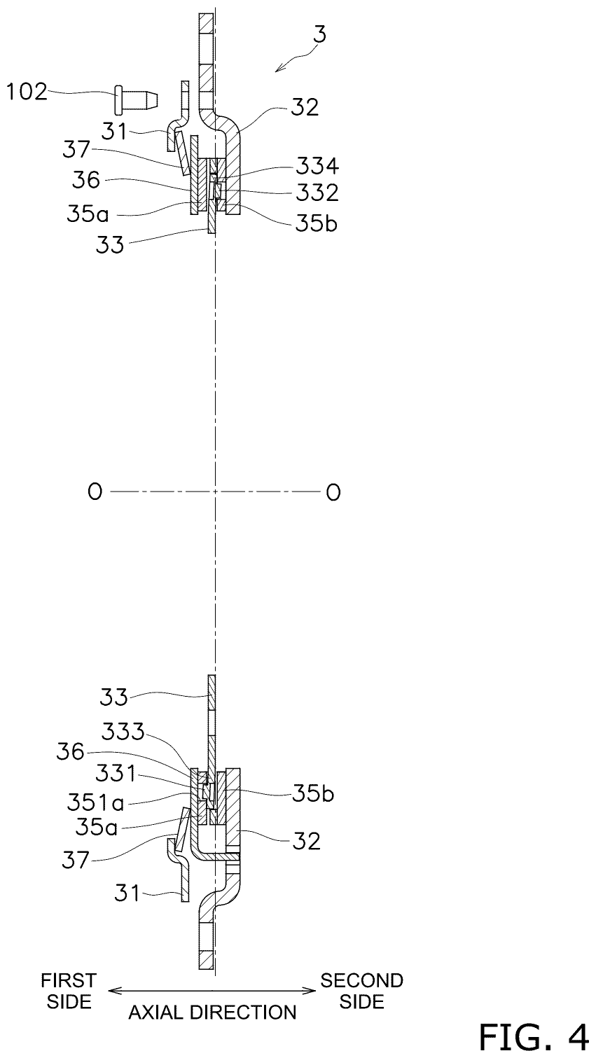

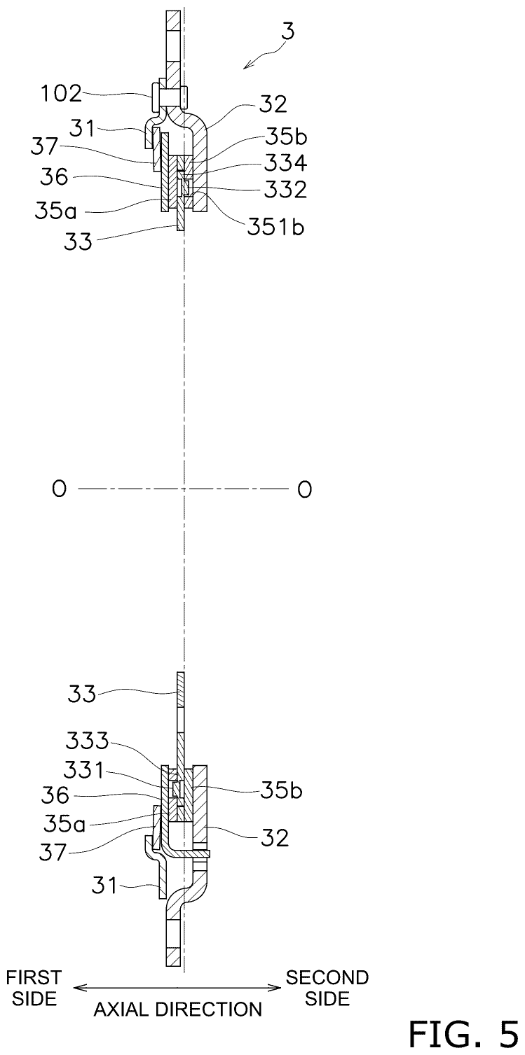

FIG. 4 is a cross-sectional view of the torque limiter 3 that has not been assembled, whereas FIG. 5 is a cross-sectional view of the torque limiter 3 that has been assembled. As shown in FIG. 4, in a condition that the torque limiter 3 has not been assembled, in other words, in a condition that an axial load has not been applied to the support plate 33, the first regions 333 are bent toward the first friction material 35a. In other words, the first regions 333 are bent to the first side in the axial direction. Because of this, it is made easy to fit the first protrusions 331 of the support plate 33 to the first through-holes 351a of the first friction material 35a, respectively.

As shown in FIG. 5, when the torque limiter 3 has been assembled, in other words, when the first side plate 31 has been fastened to the second side plate 32 by multiple rivets 102, the support plate 33, including the first regions 333, is sandwiched by the second side plate 32 and the pressure plate 36. As a result, the axial load is applied to the support plate 33 including the first regions 333, whereby the first regions 333, which have been axially bent so far, are extended radially straight.

As shown in FIG. 3, each second region 334 is defined by a pair of engaging recesses 335 disposed adjacent to each other in the circumferential direction. Each second region 334 is provided with each second protrusion 332. In other words, amongst the regions between pairs of engaging recesses 335 disposed adjacent to each other in the circumferential direction, those provided with the second protrusions 332 correspond to the second regions 334.

The first regions 333 and the second regions 334 are alternately disposed in the circumferential direction. Each adjacent pair of first and second regions 333 and 334 is divided by each engaging recess 335. Each region, disposed between each pair of engaging recesses 335, is only provided with either the first protrusion 331 or the second protrusion 332. In other words, no region is provided with both the first protrusion 331 and the second protrusion 332.

As shown in FIG. 4, in the condition that the torque limiter 3 has not been assembled, in other words, in the condition that the axial load has not been applied to the support plate 33, the second regions 334 are bent toward the second friction material 35b. In other words, the second regions 334 are bent to the second side in the axial direction. Because of this, it is made easy to fit the second protrusions 332 of the support plate 33 to the second through-holes 351b of the second friction material 35b, respectively.

As shown in FIG. 5, when the torque limiter 3 has been assembled, in other words, when the first side plate 31 has been fastened to the second side plate 32 by the multiple rivets 102, the support plate 33, including the second regions 334, is sandwiched by the second side plate 32 and the pressure plate 36. As a result, the axial load is applied to the support plate 33 including the second regions 334, whereby the second regions 334, which have been axially bent so far, are extended radially straight.

### Auxiliary Plates

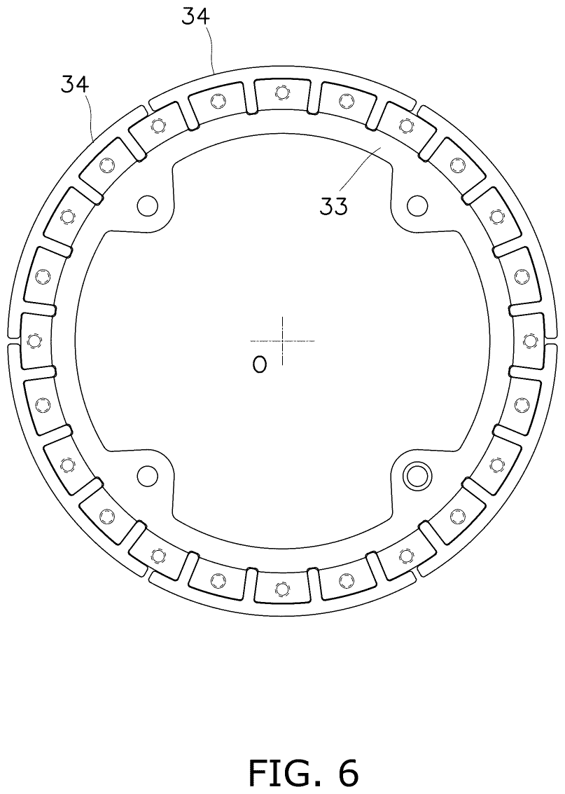

FIG. 6 is a front view of the auxiliary plates 34 attached to the support plate 33. As shown in FIG. 6, the auxiliary plates 34 are disposed radially outside the support plate 33. The auxiliary plates 34 are attached to the support plate 33. The auxiliary plates 34 are unitarily rotated with the support plate 33.

In the presently preferred embodiment, the torque limiter 3 includes six auxiliary plates 34. The auxiliary plates 34 are aligned in an annular shape. In other words, the auxiliary plates 34 are aligned in the circumferential direction. The auxiliary plates 34 are spaced apart from each other at intervals in the circumferential direction. It should be noted that the auxiliary plates 34 may be in contact with each other.

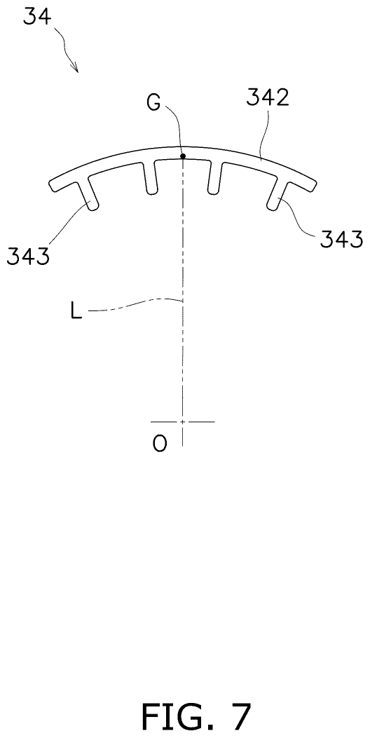

FIG. 7 is a front view of each auxiliary plate 34. As shown in FIG. 7, each auxiliary plate 34 includes a plate body 342 and multiple engaging protrusions 343. It should be noted that in the presently preferred embodiment, each auxiliary plate 34 includes four engaging protrusions 343. The plate body 342 extends in the circumferential direction. The plate body 342 is made in the shape of a circular arc about the rotational axis O.

The engaging protrusions 343 extend radially inward from the plate body 342. The engaging protrusions 343 are spaced apart from each other at intervals in the circumferential direction. The engaging protrusions 343 are engaged with the engaging recesses 335. Each engaging protrusion 343 is identical in extending direction to each engaging recess 335. Each engaging protrusion 343 is substantially identical in shape to each engaging recess 335. When the engaging protrusions 343 are engaged with the engaging recesses 335, each auxiliary plate 34 is attached to the support plate 33.

Each engaging protrusion 343 extends to slant with respect to an imaginary line L connecting the rotational axis O and the center of gravity (G) of each auxiliary plate 34. It should be noted that each engaging recess 335 extends in a comparable manner to each engaging protrusion 343. Because of this, even if a centrifugal force acts on each auxiliary plate 34 by rotation of the power transmission device 100, each engaging protrusion 343 is locked to the inner wall surface of each engaging recess 335, whereby each auxiliary plate 34 can be prevented from moving radially outward and from being thereby detached from the support plate 33.

Each engaging protrusion 343 extends toward the rotational axis O. It should be noted that each engaging recess 335 extends in a comparable manner to each engaging protrusion 343. The multiple engaging protrusions 343 are disposed on both sides of the center of gravity G of each auxiliary plate 34 in the circumferential direction. It should be noted that in the presently preferred embodiment, two of the engaging protrusions 343 are disposed on the right side of the center of gravity G, whereas the remaining two engaging protrusions 343 are disposed on the left side of the center of gravity G. Accordingly, each auxiliary plate 34 can be more reliably prevented from moving radially outward and from being thereby detached from the support plate 33.

### Friction Materials

As shown in FIG. 2, the first friction material 35a is disposed axially between the support plate 33 and the pressure plate 36. The first friction material 35a is disposed adjacent to the support plate 33 and the auxiliary plates 34 in the axial direction.

The first friction material 35a includes the first through-holes 351a. The first through-holes 351a penetrate the first friction material 35a in the axial direction. The first friction material 35a is attached to the support plate 33. In particular, the first protrusions 331 of the support plate 33 are engaged with the first through-holes 351a of the first friction material 35a, whereby the first friction material 35a is attached to the support plate 33. The first friction material 35a is unitarily rotated with the support plate 33.

The first friction material 35a has an annular shape. The first friction material 35a extends to a range of the support plate 33 and the auxiliary plates 34. In other words, when axially seen, the first friction material 35a overlaps with both the support plate 33 and the auxiliary plates 34. The inner diameter of the first friction material 35a is smaller than the outer diameter of the support plate 33. The outer diameter of the first friction material 35a is larger than that of the support plate 33. Additionally, the outer diameter of the first friction material 35a is less than or equal to that of each auxiliary plate 34. It should be noted that in the presently preferred embodiment, the outer diameter of the first friction material 35a is substantially equal to that of each auxiliary plate 34. Additionally, the term “outer diameter” of each auxiliary plate 34 means the length from the rotational axis O to the outer peripheral edge of each auxiliary plate 34.

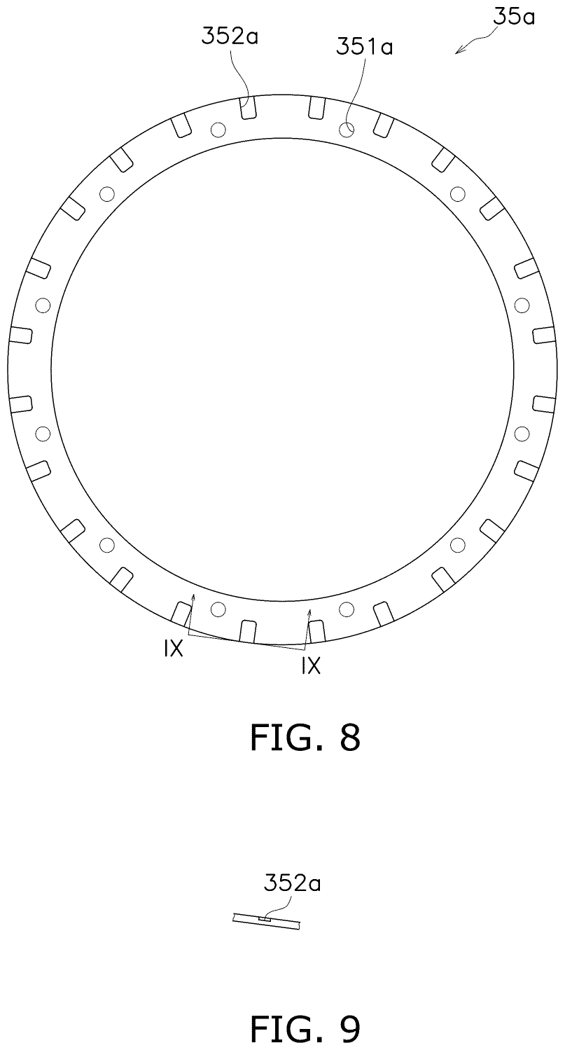

FIG. 8 is a front view of the first friction material 35a seen from the second side in the axial direction, whereas FIG. 9 is a view of the first friction material 35a taken along arrow IX-IX in FIG. 8. As shown in FIGS. 8 and 9, the first friction material 35a includes multiple grooves 352a. The grooves 352a are spaced apart from each other at intervals in the circumferential direction. The grooves 352a are disposed at identical pitches to the engaging protrusions 343. The width of each groove 352a is larger than that of each engaging protrusion 343. Here, the term “width” of not only each groove 352a but also each engaging protrusion 343 means the circumferential dimension thereof. Each groove 352a extends in the radial direction. Each groove 352a is opened radially outward.

The grooves 352a are provided on one of the two surfaces of the first friction material 35a, i.e., the surface coming in contact with the support plate 33 and the auxiliary plates 34. In other words, the grooves 352a are provided on one of the two surfaces of the first friction material 35a, i.e., the surface facing the second side in the axial direction. The grooves 352a do not penetrate the first friction material 35a in the axial direction.

FIG. 10 is a front view of the torque limiter 3. As shown in FIG. 10, when axially seen, each groove 352a overlaps with a boundary between each engaging recess 335 and each engaging protrusion 343. With the configuration, when water is accumulated in a gap between each engaging recess 335 and each engaging protrusion 343, the accumulated water can be discharged to the outside through each groove 352a. Preferably, when axially seen, each groove 352a overlaps with a root portion of each engaging protrusion 343.

As shown in FIG. 2, the second friction material 35b is disposed axially between the support plate 33 and the second side plate 32. The second friction material 35b is disposed adjacent to the support plate 33 and the auxiliary plates 34 in the axial direction.

The second friction material 35b includes the second through-holes 351b. The second through-holes 351b penetrate the second friction material 35b in the axial direction. The second friction material 35b is attached to the support plate 33. More particularly, the second protrusions 332 of the support plate 33 are engaged with the second through-holes 351b of the second friction material 35b, whereby the second friction material 35b is attached to the support plate 33. The second friction material 35b is unitarily rotated with the support plate 33.

The second friction material 35b has an annular shape. The second friction material 35b extends to a region of the support plate 33 and the auxiliary plates 34. In other words, when axially seen, the second friction material 35b overlaps with both the support plate 33 and the auxiliary plates 34. The inner diameter of the second friction material 35b is smaller than the outer diameter of the support plate 33. The outer diameter of the second friction material 35b is larger than that of the support plate 33. Additionally, the outer diameter of the second friction material 35b is smaller than or identical to that of each auxiliary plate 34. It should be noted that in the presently preferred embodiment, the outer diameter of the second friction material 35b is substantially equal to that of each auxiliary plate 34.

### Pressure Plate

The pressure plate 36 has an annular shape. The pressure plate 36 is disposed axially between the disc spring 37 and the support plate 33. In detail, the pressure plate 36 is disposed axially between the first friction material 35a and the disc spring 37. The inner diameter of the pressure plate 36 is smaller than that of the first friction material 35a. Additionally, the outer diameter of the pressure plate 36 is larger than that of the first friction material 35a. In other words, the pressure plate 36 is enabled to press the entire surface of the first friction material 35a.

The pressure plate 36 is configured to be unitarily rotated with the second side plate 32. It should be noted that the pressure plate 36 is axially movable with respect to the second side plate 32.

### Disc Spring

The disc spring 37 is disposed axially between the support plate 33 and the first side plate 31. More particularly, the disc spring 37 is disposed axially between the first side plate 31 and the pressure plate 36. The disc spring 37 urges the pressure plate 36 to the second side in the axial direction. In other words, the disc spring 37 urges the pressure plate 36 toward the support plate 33. Accordingly, the support plate 33, the first friction material 35a, and the second friction material 35b are sandwiched by the pressure plate 36 and the second side plate 32.

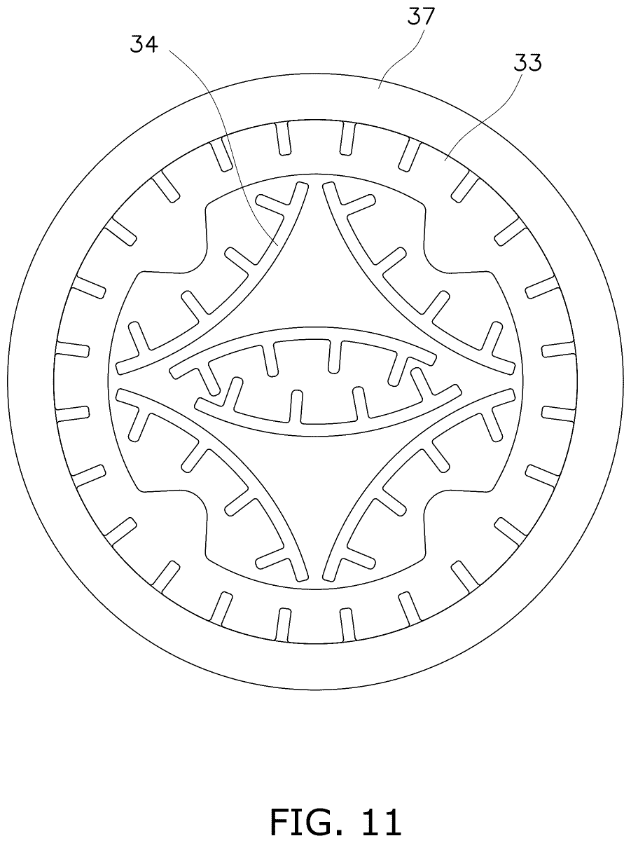

The disc spring 37 has an annular shape. As shown in FIG. 11, the disc spring 37 is taken together with the support plate 33 from a sheet of plate by nested-based manufacturing. Because of this, the inner diameter of the disc spring 37 is set to be greater than or equal to the outer diameter of the support plate 33. Additionally, the disc spring 37 is equal in plate thickness to the support plate 33.

In addition to the disc spring 37 and the support plate 33, the multiple auxiliary plates 34 are taken from the sheet of plate as well by nested-based manufacturing. The multiple auxiliary plates 34 are taken from a region enclosed by the support plate 33. FIG. 11 is a plan view of the sheet of plate, from which the support plate 33, the disc spring 37, and the plural auxiliary plates 34 are taken.

As shown in FIG. 2, the disc spring 37 is in contact at the outer peripheral end thereof with the first side plate 31, while in contact at the inner peripheral end thereof with the pressure plate 36. The inner peripheral edge of the disc spring 37 is disposed radially outside the outer peripheral edge of the support plate 33. Additionally, the inner peripheral edge of the disc spring 37 is disposed radially inside the outer peripheral edges of the auxiliary plates 34. In other words, when axially seen, the disc spring 37 overlaps with the auxiliary plates 34. Because of this, the first friction material 35a can be uniformly applied with a load.

### Modifications

One preferred embodiment of the claimed invention has been explained above. However, the claimed invention is not limited to the above, and a variety of changes can be made It without departing from the scope of the claimed invention. It should be noted that basically speaking, respective modifications to be described are applicable simultaneously.

For example, the first and second friction materials 35a and 35b may be attached not to the support plate 33 but to the auxiliary plates 34. Additionally, the first and second friction materials 35a and 35b may be attached to either the support plate 33 or the auxiliary plates 34 by any other suitable means such as an adhesive.

### LIST OF REFERENCE NUMERALS

3: Torque limiter, 31: First side plate, 32: Second side plate, 33: Support plate, 331: First protrusion, 332: Second protrusion, 333: First region, 334: Second region, 335: Engaging recess, 34: Auxiliary plate, 342: Plate body, 343: Engaging protrusion, 35a: First friction material, 351a: First through hole, 352a: Groove, 35b: Second friction material, 351b: Second through hole, 36: Pressure plate, 37: Disc spring, 4: Damper unit, 41: Input rotor, 42: Output rotor, 43: Elastic member, 100: Power transmission device

1. A torque limiter, comprising:
a first side plate having an annular shape;
a support plate having an annular shape, the support plate spaced apart from the first side plate at an interval in an axial direction;
a plurality of auxiliary plates attached to the support plate, the plurality of auxiliary plates disposed radially outside the support plate, the plurality of auxiliary plates aligned in an annular shape;
a disc spring disposed between the support plate and the first side plate in the axial direction; and
a first friction material disposed between the support plate and the disc spring in the axial direction, the first friction material disposed adjacent to the support plate and each of the plurality of auxiliary plates, wherein
an inner peripheral edge of the disc spring is disposed radially outside an outer peripheral edge of the support plate, the inner peripheral edge of the disc spring disposed radially inside an outer peripheral edge of the each of the plurality of auxiliary plates.

2. The torque limiter according to claim 1, wherein
the support plate includes a plurality of engaging recesses, the plurality of engaging recesses extending radially inward from an outer peripheral surface of the support plate, and
each of the plurality of auxiliary plates includes a plate body and an engaging protrusion, the engaging protrusion extending radially inward from the plate body, the engaging protrusion engaged with a corresponding one of the plurality of engaging recesses.

3. The torque limiter according to claim 2, wherein the engaging protrusion and the corresponding one of the plurality of engaging recesses extend to slant with respect to an imaginary line connecting a center of gravity of the each of the plurality of auxiliary plates and a rotational axis of the torque limiter.

4. The torque limiter according to claim 2, wherein
the engaging protrusion is one of at least two engaging protrusions included in said each of the plurality of auxiliary plates, the at least two engaging protrusions disposed on both sides of a center of gravity of said each of the plurality of auxiliary plates in a circumferential direction, and
each of the at least two engaging protrusions and each of the plurality of engaging recesses extend toward a rotational axis.

5. The torque limiter according to claim 2, wherein
the first friction material includes a groove provided on a surface thereof coming in contact with the support plate and said each of the plurality of auxiliary plates, the groove opened radially outward, and
the groove overlaps with a boundary between the engaging protrusion and the corresponding one of the plurality of engaging recesses as seen in the axial direction.

6. The torque limiter according to claim 1, further comprising:
a second side plate having an annular shape, the second side plate disposed to interpose the support plate, said each of the plurality of auxiliary plates, the disc spring, and the first friction material together with the first side plate therebetween;
a pressure plate disposed between the disc spring and the first friction material in the axial direction; and
a second friction material disposed between the support plate and the second side plate in the axial direction.

7. The torque limiter according to claim 2, further comprising:
a second side plate having an annular shape, the second side plate disposed to interpose the support plate, said each of the plurality of auxiliary plates, the disc spring, and the first friction material together with the first side plate therebetween;
a pressure plate disposed between the disc spring and the first friction material in the axial direction; and
a second friction material disposed between the support plate and the second side plate in the axial direction, wherein
the first friction material includes a first through-hole penetrating therethrough in the axial direction,
the second friction material includes a second through-hole penetrating therethrough in the axial direction,
the support plate includes a first protrusion, a second protrusion, a first region, and a second region, the first protrusion protruding toward the first friction material to be engaged with the first through-hole, the second protrusion protruding toward the second friction material to be engaged with the second through-hole, the first region provided with the first protrusion, the first region defined by one pair of engaging recesses disposed adjacent to each other in a circumferential direction among the plurality of engaging recesses, the second region provided with the second protrusion, the second region defined by another pair of engaging recesses disposed adjacent to each other in the circumferential direction among the plurality of engaging recesses,
the first region is configured to be extended straight from a state thereof bent toward the first friction material when sandwiched by the pressure plate and the second side plate, and
the second region is configured to be extended straight from a state thereof bent toward the second friction material when sandwiched by the pressure plate and the second side plate.

8. The torque limiter according to claim 1, wherein the disc spring is equal in plate thickness to the support plate.

9. A power transmission device comprising:
the torque limiter according to claim 1; and
a damper unit including an input rotor, an output rotor, and an elastic member, the input rotor configured to be unitarily rotated with the support plate, the elastic member elastically coupling the input rotor and the output rotor.
